(19) United States
(12) Patent Application Publication
(10) Pub. No.: US 2008/0066099 A1
(43) Pub. Date: Mar. 13, 2008

(54) Media systems with integrated content searching

(75) Inventors: Rainer Brodersen, San Jose, CA (US); Rachel Clare Goldeen, Mountain View, CA (US); Mihnea Calin Pacurariu, Los Gatos, CA (US); Jeffrey Ma, Redwood City, CA (US)

Correspondence Address: FISH & RICHARDSON P.C., PO BOX 1022, MINNEAPOLIS, MN, 55440-1022, US

(73) Assignee: APPLE COMPUTER, INC., Cupertino, CA (US)

(21) Appl. No.: 11/549,092

(22) Filed: Oct. 12, 2006

Related U.S. Application Data
(60) Provisional application No. 60/825,233, filed on Sep. 11, 2006.

(51) Int. Cl. H04N 7/10; H04N 7/16; H04N 7/173; H04N 7/025

(52) U.S. Cl. 725/35; 725/34; 725/135; 725/100

(57) ABSTRACT

Systems and methods for providing related commercial content to a user. Systems and methods can include extraction or development of data from metadata and searching for related commercial content based upon the extracted or developed data.

### BACKGROUND

This disclosure relates to providing content to a media device.

Historically, video content for television was free broadcast video content. The revenue model for content providers was to sell advertising during the free broadcast content. The advent of cable television systems has significantly changed the business model for content providers in many instances. For example, content providers such as Home Box Office (HBO), available from Home Box Office, Inc. of New York, N.Y., provide broadcast content by subscription service and reduce (or altogether eliminate) advertising. Thus, the primary source of revenue for such providers are subscription services.

With the implementation of digital technology in many conventional cable and satellite systems, the broadcast content is supplemented by metadata content. The metadata content can be provided by a metadata content provider on a sideband signal to the digital video content signal, or by another alternative mechanism. The metadata enables electronic program guides, which can provide media system users with programming schedules and detailed program information, such as, for example, actors, directors, ratings, reviews, etc. However, such metadata content has traditionally only been used to provide broadcast content to media system users.

### SUMMARY

In one aspect, systems, methods, apparatuses and computer program products are provided. A media system can include a video input, a network interface, a metadata input, and a correlation engine. The video input can be configured to receive video content from a content provider, while the network interface can be configured to send content requests and receive commercial content from a commercial content provider. The metadata input can be configured to receive metadata content from a metadata provider. The metadata can be associated with the video content or the commercial content. The correlation engine can be configured to extract a portion of the metadata associated with the video content or the commercial content, and to request related commercial content using the network interface, and based upon an extracted/developed portion of metadata and input received from a user.

In another aspect, methods are disclosed which provide commercial content to a user. Such methods can include: receiving video content or commercial content from a content provider; receiving metadata from a metadata provider, the metadata being associated with the received content; extracting metadata associated with the received content; searching a network for commercial content related to the extracted metadata; and receiving related commercial content from the content provider based on the extracted metadata.

Media systems and methods as described can facilitate access to video and/or audio content, even where the video and/or audio content is not distributed by a broadcast content provider. The media systems and methods can also: aid a user in locating video and/or audio content that might be of interest to the user, by extracting metadata based upon user input and searching for content related to the extracted metadata; provide expedient methods by which a distributor can market and merchandise related commercial products; and, provide advertisers with a link to consumers, by allowing consumers to order merchandise associated with a metadata tagged advertisement.

### BRIEF DESCRIPTION OF THE DRAWINGS

FIG. 1 is a block diagram of an exemplary media system having a network search interface used to search for related commercial content.

FIG. 2 is a block diagram illustrating an example network including a media system.

FIG. 3 is a block diagram illustrating another example network including a media system.

FIG. 4 is a flowchart illustrating an exemplary method for providing commercial content.

FIG. 5 is a flowchart illustrating another exemplary method for providing commercial content.

FIG. 6 is a flowchart illustrating another exemplary method for providing commercial content.

FIG. 7 is a screen shot illustrating an example of a user interface for a media system having a related content search option.

FIG. 8 is a screen shot illustrating an example of a user interface having a number of search templates which the user can select to cause the media system to perform a search.

FIG. 9 is a screen shot illustrating an example of a user interface enabling a user to select commercial content from among commercial content and broadcast content.

### DETAILED DESCRIPTION

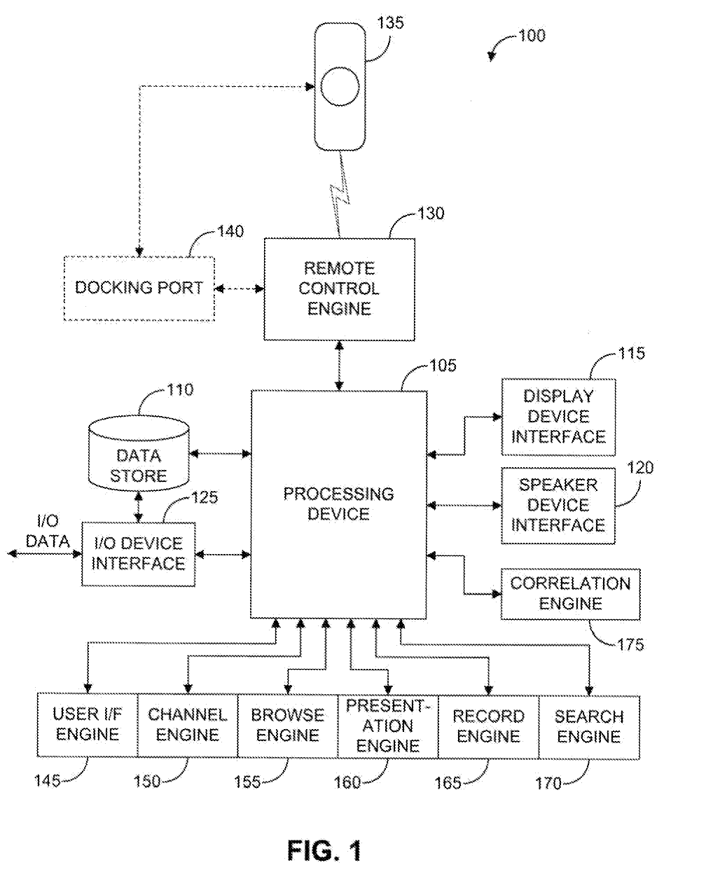

FIG. 1 is a block diagram of a media system 100. Media systems 100 of various implementations can include a set-top box with or without a digital video recorder (DVR) (or, personal video recorder (PVR)). In another example implementations, media systems can include a display with built-in functionality (e.g., a television), a computer system, a phone, a PDA, an iPOD® (available from Apple Computers, Inc. of Cupertino, Calif.), or any other media environment. In other implementations, portions of the functionality of FIG. 1 can be provided by a media card, while other functionality can be provided by a display device or other processing device. Media systems 100 can be used to connect a media environment to a video content provider, such as a cable service provider, for example.

In the example of FIG. 1, the media system includes DVR functionality. The media system 100 can include, for example, a processing device 105, a data store 110, a display interface 115, a speaker interface 120, and other input/output (I/O) device interfaces 125, through which I/O data can be received or transmitted. I/O devices of various examples can include a network interface from an internet service provider (ISP) for example, an external hard drive, a power supply, a keyboard, a DVD player and/or recorder, a receiver, etc. The above list is not intended to be exhaustive, but merely provide a few examples of the functionality that can be provided using various I/O devices. In various examples, the media system 100 can include network storage or an alternative data feed in place of, or in addition to the data store 110.

In one implementation, the functionality of the media system 100 is distributed across several engines. For example, the media system 100 may include a remote control engine 130, a user interface (UI) engine 145, a channel engine 150, a browse engine 155, a presentation engine 160, a recording engine 165, a search engine 170, and a correlation engine 175. The engines may be implemented in software as software modules or instructions, hardware, or in a combination of software and hardware. The software can be stored in a data store (e.g., data store 110, flash memory, external memory, read-only memory (ROM), nominally powered volatile memory, etc.) during periods to which the media system 100 is in a standby mode. Upon power up, the software is communicated to the processing device 105. The processing device 105 then executes the software by performing the commands implicated by the software.

In some implementations of media systems 100, the I/O device interface 125 operates a hardware component operable to receive signals from a remote control 135, which can be routed through the remote control engine 130 to process the received signals. However, for clarity, FIG. 1 shows the remote control 135 being connected to the system using the remote control engine. As such, the remote control engine 130 of FIG. 1 to contain hardware which enables the media system to communicate with the remote control 135. The remote control engine 130 can also include software used to decode signals and provide commands from the user to any of a number of other engines being executed by the processing device 105.

Numerous types of protocols and physical media can provide a communication link between the remote control 135 and the remote control engine 130, including, among others, radio frequency (RF) media, infrared (IR) media, and wired media.

Some media system implementations can include a docking port 140. The docking port can provide a wired or wireless communication connection between the remote control 135 and the remote control engine 130. In some examples, the remote control 135 itself is a handheld personal media device operable to receive, store and playback audio and/or video, such as, for example, an iPOD®. As such, the docking port can provide a mechanism by which a user can manage any downloaded content (e.g., audio and/or video content) stored in volatile or non-volatile memory of the handheld personal media device.

A user interface engine 145 operates in conjunction with the processing device 105 and provides a graphical user interface to the user through a display device interface 115. The graphical user interface can provide the user with a number of interactive menus that can be selectively navigated by a user. An example of a menu implementation can include an electronic program guide or interactive program guide. Electronic program guides can offer a user the ability to view a list of scheduled programs, as well as read information about the programs, set a DVR to record various programs, set reminders for programs, search for upcoming programs, etc. Other menu implementations can include program information which can be accessed while watching a program.

Program information can be obtained using a metadata content provider, such as for example, Tribune TV Data, available from Tribune Media Services, Inc., of Chicago, Ill,, or Gemstar TV guide, available from Gemstar-TV Guide International, Inc., of Los Angeles, Calif. the metadata can be pushed or pulled from the metadata content provider. Many DVR systems operate using a system whereby the metadata is periodically sent to the DVR using the same broadcast transport stream as the video content data or on a data stream alongside the broadcast transport stream. However, there are many ways to disseminate the metadata information, including using an internet connection, which can be a dedicated connection or multi-purpose connection.

A channel engine 150 operates in conjunction with the processing device 105 and the user interface engine 145 to provide information (e.g., an electronic program guide or channel information) to a user. The channel engine 150 can collect metadata information and associate the metadata information with a particular channel or program.

The media system 100 further includes a browse engine 155. The browse engine 155 in conjunction with the processing device 105, the user interface engine 145 and the channel engine 150 operate to enable the user to browse through an electronic program guide or a reduced program guide. The browse engine 155 can interact with the channel engine 145 to locate metadata for currently browsed channels. The browse engine 155 can provide the framework, including for example channel slots and time slots, into which metadata from the channel engine 150 can be inserted. This framework can then be sent to an output display using the user interface engine 145.

The media system 100 of FIG. 1 can also include a presentation engine 160. The presentation engine 160 in conjunction with the processing device 105 controls the presentation of a content to the user. The presentation engine 160 can decode a broadcast data stream and provide the content to a display device interface 115, a speaker device interface 120, or combinations thereof. The presentation engine 160 can provide the content in a number of formats. For example, the presentation engine 160 can provide a component video stream to the display device interface 115, a composite video stream to the display device interface 115, a 5.1 channel signal in Dolby Digital or DTS format, or other video or audio streams.

The media system of FIG. 1 also includes a recording engine 165. The recording engine 165 in conjunction with the processing device 105 operates to manage recording of audio and/or video content. In some implementations the record engine 165 can include various routines used to interface with the user to schedule recordings, track disk space, automatically maintain and delete recordings based on user input received using the user interface. In some implementations recording engine 165 include tools to erase programs when more space is needed, or to alert the user when the space is low. These and other types of features can be facilitated by the recording engine 165.

The media system of FIG. 1 also includes a search engine 170. The processing device 105 executes the search engine 170 and thereby enables users to search, for example among the metadata content received from the metadata provider, as described above. The search engine 170 can allow users to enter search parameters using the user interface engine 145. The search engine 170 can use the input parameters to search from among the metadata content stored in the data store. There are many searching algorithms that can be used to perform a search from among a collection of data, including list searches, tree searches, etc. Selection of a particular search algorithm can be, for example, dependant on the data structure used to store the metadata or by the processing power included in the processing device.

The media system 100 also includes a correlation engine 175. The correlation engine 175 is executed by the processing device 105 and extracts or develops data from the metadata content (e.g., for various parameters requested by the user). The extracted/developed data can be used to perform a search (e.g., using the internet) for commercial content related to video content or audio content currently being presented to the user, or related to selected video or content received from the user. In various implementations, commercial content can include fee-based downloads (e.g., video or audio content), as well as merchandise (e.g., hats, t-shirts, toys, and other content related merchandise) being offered for sale.

In some implementations, the user can choose a predefined search template to determine which of the data is to be extracted from the metadata content. The predefined search template, in various examples, can cause the correlation engine 175 to extract any of actors, directors, producers, writers, genre, or combinations thereof, among others. The correlation engine 175 then uses the extracted data to perform a search for related commercial content. The correlation engine 175 can interact with the user using the user interface engine 145 to obtain further definition of the search parameters. For example, where the metadata includes for four actors, the correlation engine 175 can provide the user with an opportunity to narrow the search to one or more of the actors, rather than any of the actors.

The related commercial content can include a variety of different types of content (e.g., audio, video, merchandise, etc., and combinations thereof). For example, in some implementations, the correlation engine 175 can be configured to return only commercial video content or commercial audio content. Commercial video content can include video content that is related to the current video content being presented by the media system, such as, for example, related episodes of a television series or shows that are defined by similar genre parameters, the same actor(s), the same directors, etc. Commercial audio content can include audio content that is related to the current video content being presented by the media system, such as, for example, a soundtrack to a movie, music used in a television series (e.g., a theme song, or a song used in the episode), music related to one of the actors (e.g., an actor's favorite music), etc. Further still, the correlation engine 175 can be configured to search for television series or commercial paraphernalia (e.g., t-shirts, hats, digital video discs (DVDs), props, products, etc.) related to the currently displayed content.

In some example implementations of media systems 100, advertising content can have metadata associated with the advertising content. In such implementations, media systems 100, responsive to input from a user, can examine metadata associated with the advertising content and cause a search to be performed for a product or service related to the advertising content.

Moreover, the correlation engine 175 can be configured to operate in conjunction with the search engine 170 to return both related broadcast content and related commercial content. The user can communicate with the correlation engine 175 using the user interface engine 145 to select one or more of the related broadcast content and/or related commercial content. Upon selection of commercial content the correlation engine 175 can manage the download of the related commercial content from a commercial content provider. An intermediate step can be added in some examples, whereby the user is prompted to agree to a debit against his or her account based on a price associated with the related commercial content.

In various implementations, commercial content providers can include libraries such as iTunes, available from Apple Computers, Inc., of Cupertino, Calif. CinemaNow libraries, available from CinemaNow, Inc. of Marine del Rey, Calif., MovieLink libraries, available from MovieLink, LLC, of Santa Monica, Calif., or Vongo, available from Liberty Media Corporation, of Englewood, Calif., among many others, and combinations thereof. The correlation engine 175 can also be configured to debit a customer'a account in response to downloading commercial content. The amount of the debit can equal to the amount charged by the commercial content provider. In one implementation the provider of the media system 100 can choose to charge more or less than the amount charged by the commercial content provider.

The media processing system 100 of FIG. 1 can also implement different functional distribution architectures that have additional functional blocks or fewer functional blocks. For example, the channel and recording engines 150 and 165 can be implemented in a single functional block, and the browse and search engines 155 and 170 can be implemented in another functional block. Alternatively, all of the engines can be implemented in a single monolithic functional block.

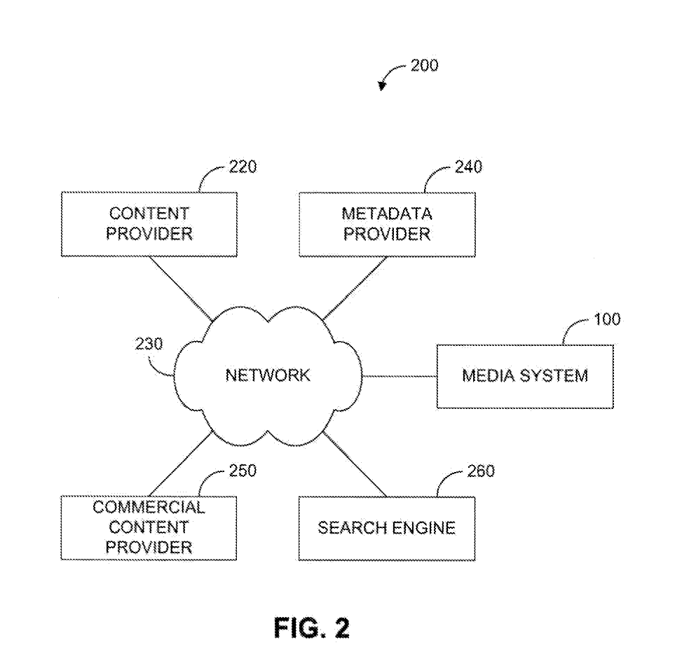

FIG. 2 is a network diagram showing an example implementation 200 of media system(s) 100. The media system(s) 100 can receive video content broadcast from a content provider 220 using a network 230. The media system 100 can also receive metadata from a metadata provider 240 using the network 230. The metadata received from the metadata content provider 240 can include a schedule for the content received from the content provider 220, as well as information about the content received from the content provider 220.

The schedule received from the metadata provider 240 can include a list of program titles associated with time slots for numerous channels received from the content provider 220. In some implementations schedule information can be provided, for example, for up to three weeks of future broadcast content, or up to any future period of time provided by a metadata provider 340.

The information about the broadcast content can include a number of information fields associated respectively with the various program titles. For example, information fields can include a rating (e.g., a Motion Picture Association of America (MPAA) rating), actors/actresses appearing in the movie, director, a summary description of the content, and/or a critical rating. The information fields and an associated program title can be displayed to the user using the media system 100.

In some implementations, the media system 100 can receive input from a user to retrieve commercial content from a commercial content provider 250 based upon the user's input. In particular, the media system 100 can retrieve related commercial content based upon currently selected content (e.g., content currently being presented, title selected from an interactive program guide or condensed program guide, broadcast or commercial, etc.). The related commercial content can be retrieved by extracting or developing search terms from the metadata received from the metadata provider 240.

Upon extracting/developing the search terms, the media system 100 can communicate with a search engine 260 to provide the search terms to the search engine 260. The search engine 260 can search any number of related or unrelated network databases and, for example, can respond to the search terms by sending a link to any related commercial content found. The network databases, for example, can include formal and/or informal sources of metadata and/or content. As an example, formal sources of metadata can include internet sites such as iTunes, imdb.com, available from Amazon.com, Inc., of Seattle, Wash., etc. Informal metadata sources, for example, can include peer media systems, social networking sites, user administrated sites, etc.

In some examples, the search engine 260 can be part of a commercial content provider 250. The commercial content provider 250 can offer a user the opportunity to purchase content using the media system 100. The content provider 220 can debit the user's account based upon purchases made with the media system 100. However, in some implementations of the media system 100, the user can provide his/her credit card information using the user interface and pay the commercial content provider 250 directly for the commercial content.

The network 230 can take various forms, such as, for example, a cable television network, a packet switched network, a circuit switched network, etc. Further, the network 230 in various examples can include a number of sub-networks. Moreover, it is not necessary that the sub-networks have the ability to communicate with each other. For example, one of the sub-networks can be a public switched telephone network (PSTN), while another sub-network can be a cable television network, or a wireless communication network (e.g., a network under any of the Institute of Electrical and Electronics Engineers (IEEE) 802.11, cellular networks, microwave networks, etc.).

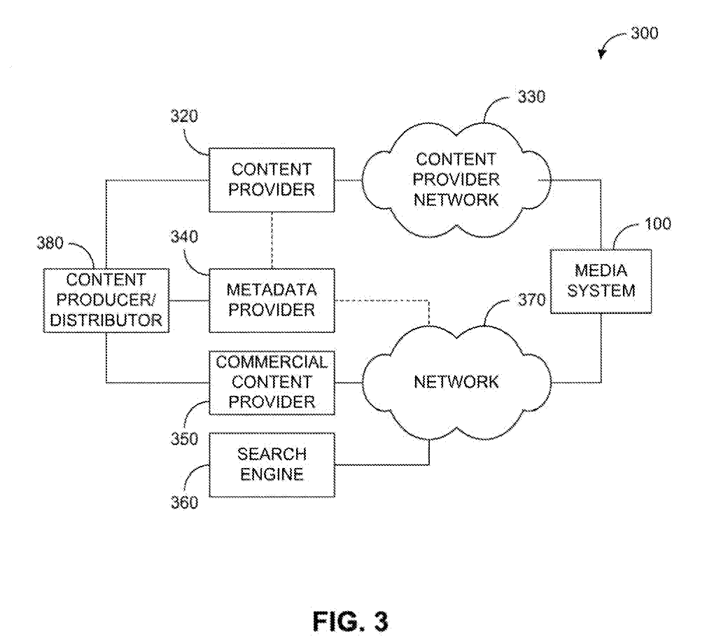

As a further illustration of the broad disclosure of the types of networks that can be included in systems and methods disclosed herein, FIG. 3 is a diagram illustrating another example network including a media system 100. The media system 100 can be connected to a content provider 320 using a content provider network 330, and to commercial and other services 340-360 using a separate network 370.

In this implementation, the content provider 320 provides broadcast content to the media system 100 using the content provider network 330. The content provider network can be alternatively implemented using a number of different networks or network configurations, including a cable television network, a satellite network (such as direct broadcast satellite (DBS)), wireless networks, among many others. The broadcast content can be provided in a variety of different formats (analog or digital), including various coding schemes.

While the content provider 320 can produce and distribute original content, the content provider 320 typically operates as a last mile distribution agent for content producers/distributors 380. The content producers/distributors 380 can include, for example, various production companies that operate to produce and/or distribute television, movie or other video or audio content. The content producers/distributors 380 can use a variety of mechanisms to distribute content to various content providers.

The metadata provider 340 can be connected to the content provider 320 to receive schedule data for dissemination. Alternatively, the metadata provider 340 can receive the schedule information directly from the content producers/distributors 380 such as traditional network television producers/distributors (e.g., American Broadcasting Company (ABC), NBC, CBS, Fox, etc), or cable networks (e.g., ESPN, MTV, CNN, Comedy Central, HBO, Showtime, etc.) to receive schedule information. In some implementations, the metadata can be provided using the content provider 320 using the content provider network 330. In other implementations, the metadata can be provided to the media system 100 using a separate network 370, such as, for example, the internet.

The commercial content provider 350 operates to sell content to users over the network 370. Users can pay using a variety of different mechanisms, including, for example, a third-party account (e.g., PayPal, available from PayPal, Inc. of San Jose, Calif.), or a direct account with the commercial content provider (e.g., iTunes, available from Apple Computer, Inc., of Cupertino, Calif.). In some implementations, the commercial content provider can provide the commercial content over a network 370 such as the internet. In other examples, the commercial content provider 350 can provide content over a proprietary network, a phone network, a wireless network., etc., and combinations thereof.

The search engine 360 operates to enable searchers to search for a variety of data. In one implementation, the search engine 360 can be a proprietary search engine used to search for content from a commercial content provider 360 library of content. In such an implementation, the search engine can be associated with or provided by the commercial content provider 350. In further implementations, the search engine 360 can operate to search from a number of commercial content providers, including, for example, iTunes, Amazon.com (available from Amazon.com., Inc., of Seattle, Wash.), MovieLink, CinemaNow, Vongo, etc. This can be done by searching known commercial content provider websites individually, or by searching for the content using a global-type search engine, such as, e.g., Google, available from Google Inc. of Mountain View, Calif.

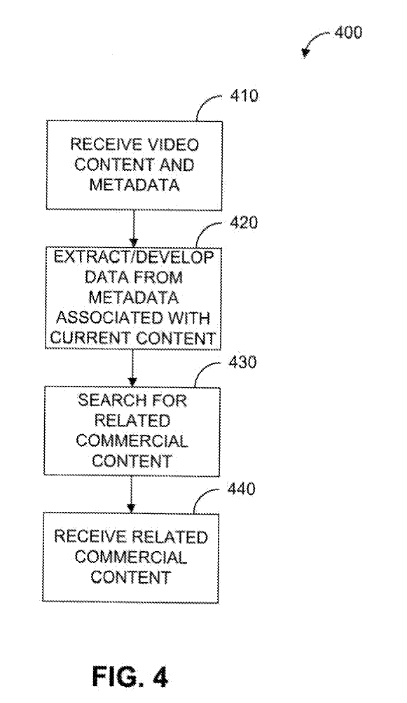

FIG. 4 shows a method 400 for providing commercial content to a media system 100. The method 400 begins at step 410 by receiving video content and metadata. As an example, step 410 can be provided by the I/O interface 125. The video content can be provided through a number of mechanisms, including, for example, cable, satellite, wireless, etc. The metadata can be provided by a metadata provider, such as for example a third party metadata provider or the video content provider.

The method 400 then extracts or develops data from the metadata received from, for example, the metadata provider, as shown in step 420. As an example, step 420 can be provided by the correlation engine 175. The extracted data can be based upon input received from the user. For example, in one implementation, the user can request movies or televisions series with the same actors as appear in a currently selected video content. In some implementations, the actors information is extracted from the metadata associated with the currently selected video content. The currently selected video content can be the video content that is currently being processed for presentation by the media system 100. Alternatively, the currently selected video content can be the video content that is currently selected using the user interface, for example, using an interactive program guide, a condensed program guide, or an information interface.

The method 400 uses the extracted data to search for related content, as shown in step 430. As an example, step 430 can be provided by the correlation engine 175 using the I/O device interface 125. As described above, the content can be related in a number of different ways. For example, in some implementations, the user can select to search based upon one or more actors or actresses, a director, a producer, a writer, a critic's selection, a celebrity selection, content related similarly to the current selection by other users, content in the same genre, peer recommendations, etc. Moreover, in other implementations, the user can select a combination of any of the foregoing search criteria.

In yet further implementations, the user may provide his or her own search criteria through the user interface. Furthermore, the user may also receive content recommendations from a friend or acquaintance or through a peer network. Such a peer network can be implemented, for example, using a buddy list, a newsgroup, or a central server, among others. The recommendations can be received at the media system (e.g., media system 100) using a network interface.

The search for content can be performed, for example, on a variety of different content provider websites (iTunes, Amazon.com. YouTube, CinemaNow, MovieLink, Vongo, eBay, NetFlix, etc.), whereby the content provider can typically provide the search engine. Alternatively, the search can be performed using a single search engine to search a variety of different internet content (e.g., Google website, Yahoo! Search, AltaVista, etc.).

The method 400 receives related commercial content, as shown in step 440. As an example, step 440 can be provided by the I/O device interface 125 of FIG. 1. The commercial content can be received at the media system 100 using a network connection. Alternatively, the commercial content can be directed through a content provider network. If the requested commercial content is video and/or audio content, the media system 100 can present the received related commercial content to the user upon receiving the commercial content. Alternatively, the media system 100 can store the received related commercial content in the data store 110 for later presentation to the user. If the requested related commercial content is merchandise, the merchandise can be requested to be sent to an address associated with the user using any of a number of different postal carriers (e.g., United States Postal Service, United Parcel Service (UPS), FedEx, DHL, etc.).

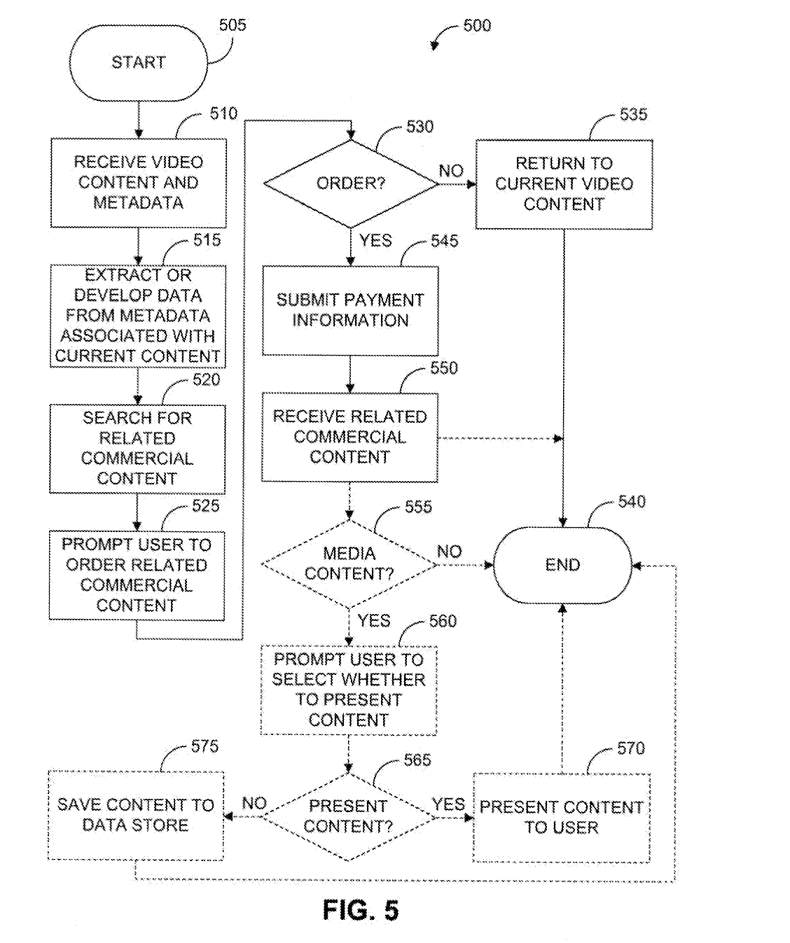

FIG. 5 is a method 500 for providing related commercial content to, for example, a media system 100. The method 500 begins at start bock 505. At step 510, the method 500 receives video and metadata content. As an example, step 510 can be provided by the I/O device interface 125 of FIG. 1. The video content can be broadcast video content (e.g., cable, DBS, over-the-air, etc.) received from a content provider using content provider network. The metadata can be received from a metadata provider using a side-band, for example, of the content provider network or using another communications network (e.g., internet, wireless network, etc.).

The method 500 continues at step 515, by extracting/developing data from the metadata. As an example, step 515 can be provided by the correlation engine 175. In one implementation, based upon user input, the user can select to extract data from among the metadata. The user input can include requesting related content to video content currently being presented by the media system 100. Alternatively, the user input can include requesting related content to metadata selected from a user interface, such as, for example, an interactive program guide, a condensed program guide, or an information interface, among others.

The extracted data serves as search criteria for a search engine. Searching for commercial content related to the extracted data (e.g., search criteria), is shown in step 520. As an example, step 520 can be provided the extraction engine 175 of FIG. 1. As noted above, the search can include searches for a variety of different content, including, for example: one or more actors, or actresses associated with the current selection; a director associated with the current selection; a producer associated with the current selection; a writer associated with the current selection; content that was critiqued similarly to the current movie; content that appears on a professional film or television critic's recommended list; content that appears on a celebrity's recommended list; and/or, a genre that is associated with the current selection.

The method 500 then prompts the user to select whether to order any of the related commercial content located during the search, as shown in step 525. As an example, step 525 can be performed by the user interface engine 145 of FIG. 1. In various implementations, the prompt can include displaying a list of content located using a search engine. Upon selection, in some implementations, the media system 100 can confirm that the user wishes to order the selected commercial content. This confirmation can typically include an amount of money that will be debited from a user account, or an interface with which the user can enter his/her credit card or other account information for billing purposes.

The method 500 determines whether the user has requested to order related commercial content in step 530. As an example, step 530 can be performed by the user interface engine 145 of FIG. 1. If the user selects not to order any related commercial content, the method proceeds to step 535, where the user is returned to the current video content. As an example, step 535 can be performed by the correlation engine 145 of FIG. 1 in conjunction with the I/O device interface 125. Alternatively, the user can be returned to a graphical user interface, such as an interactive program guide or a complete list of related content or other search criteria. The method ends at step 540.

Returning to step 530, if the user decides to order any of the related commercial content is step 530, the method 500 proceeds to step 545, whereby the user's payment information is submitted to the commercial content provider. As an example, step 545 can be performed by the correlation engine 145 of FIG. 1 in conjunction with the I/O device interface 125 of FIG. 1. The user's payment information can be provided securely, using encryption to encrypt any sensitive information, such as address, credit card number, account number, etc.

The method then receives the requested commercial content in step 550. As an example, step 525 can be performed by the I/O device interface 145 of FIG. 1. In some implementations, the method can determine whether the content is media content, as shown in step 555. As an example, step 555 can be performed by the presentation engine 160 of FIG. 1. If the related commercial content is media content, the related commercial content can be received over a network (e.g., the internet). Alternatively, the related commercial media content can be received by the media system using a content provider network.

The method 500 can then prompt the user to select whether to present the content, as shown in step 560. As an example, step 560 can be performed by the user interface engine 145 of FIG. 1. The method 500 then receives a selection from the user determining whether to present the content, as shown in step 565. As an example, step 565 can be performed by the user interface engine 145 of FIG. 1. If the user selects to present the content, the method 500 can present the content, as shown in step 570. As an example, step 570 can be presented using a display (e.g., a display, a stereo receiver, etc.) through the presentation engine 160 of FIG. 1 and the display device interface 115 of FIG. 1. However, if the user selects not to present the content, the method 500 can proceed to step 575, whereby the method 500 stores the content (e.g., to a data store 110 associated with the media system 100). As an example, step 575 can be performed by the record engine 165 of FIG. 1, in conjunction with the data store 110 of FIG. 1. The method 500 ends at block 540.

Returning to step 555, if the related commercial content is not media content (e.g., merchandise content), the commercial content can be shipped to an address associated with the media system (e.g., an account holder's address). The method 500 ends at block 540.

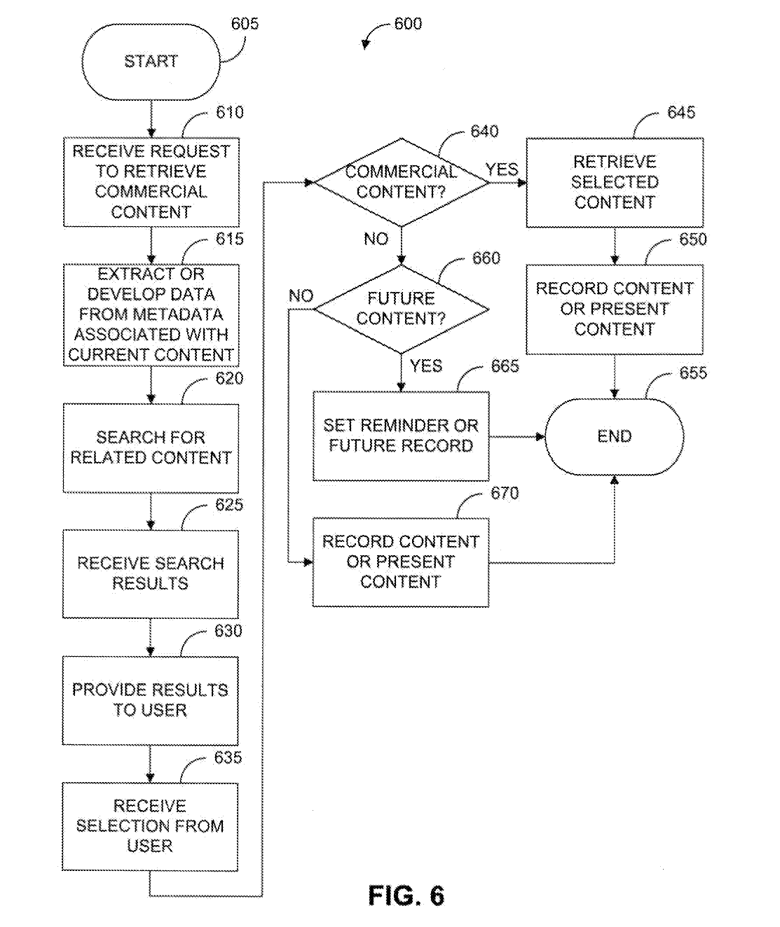

FIG. 6 is a method 600 for providing related commercial content to, for example, a media system 100. The method 600 begins at start bock 605. At step 610, the method 600 receives a request to retrieve related commercial content. As an example, the request receipt can be provided by a remote control engine 130 of FIG. 1 in conjunction with the I/O device interface 125 of FIG. 1. The request can be related to currently selected or currently presented video content. The video content can be broadcast video content (e.g., cable, DBS, over-the-air, etc.) received from a content provider using content provider network.

The method 600 continues at step 615, by extracting/developing data from the metadata associated with the currently selected video content. As an example, step 615 can be performed by the correlation engine 175 of FIG. 1. The metadata can be received from a metadata provider using a side-band, for example, of the content provider network or using another communications network (e.g., internet, wireless network, etc.). In one implementation, based upon user input, the user can select to extract data from among the metadata. The user input can include requesting related content to video content current being presented by the media system. Alternatively, the user input can include requesting related content to metadata selected from a user interface, such as, for example, an interactive program guide or a condensed program guide, among others.

The extracted/developed data serves as search criteria for a search engine. Searching for commercial content related to the extracted data (e.g., search criteria), is shown at step 620. As an example, step 620 can be performed by the correlation engine 175 of FIG. 1 in conjunction with the I/O device interface 125 of FIG. 1. As noted above, the search can include searches for a variety of different content, including, for example: one or more actors, or actresses associated with the current selection; a director associated with the current selection; a producer associated with the current selection; a writer associated with the current selection; content that was critiqued similarly to the current movie; content that appears on a professional film or television critic's recommended list; content that appears on a celebrity's recommended list; and/or, a genre that is associated with the current selection.

The method 600 then receives the search results at step 625. As an example, step 625 can be performed by the I/O device interface 125 of FIG. 1. The method 600 can then organize the search results and provide the search results to the user (e.g., using a user interface), as shown in step 630. As an example, step 630 can be performed by the user interface engine 145 of FIG. 1 in conjunction with the presentation engine 160 of FIG. 1. The results can be provided in many different forms. For example, the results can be provided to the user in a form of a list. Alternatively, the results can be categorized as commercial and non-commercial and provided separately. Commercial content can be denoted by an indicator indicating that the selection is commercial content, and that payment can be, for example, debited to an account associated with the media system 100.

Upon outputting the results of the search to the user, a selection can be received as shown in step 635. As an example, step 635 can be performed by the user interface engine 145 of FIG. 1 in conjunction with the I/O device interface 125 of FIG. 1. The selection step 635 can include a confirmation of the selection. The selection of then examined in step 640 to determine whether the selected content is related commercial content. As an example, step 640 can be performed by the correlation engine 175 of FIG. 1. If the content is related commercial content, the method 600 retrieves the commercial content (e.g., from a commercial content provider) as shown in step 645. As an example, step 645 can be performed by the correlation engine 175 of FIG. 1 in conjunction with the I/O device interface 125 of FIG. 1.

After retrieving the commercial content, the method 600 can determine whether to present the retrieved commercial content, or to store the retrieved commercial content, as shown in step 650. As an example, step 650 can be performed by the presentation engine 175 of FIG. 1 in conjunction with the record engine. Alternatively, step 650 can be performed by the user interface engine 145 of FIG. 1 in conjunction with the display device interface 115 and the I/O device interface 125 of FIG. 1. The determination can be made based upon predefined preferences on the media system 100. The user can be prompted to selected whether to present the commercial content using the media system 100, and/or whether to store the commercial content for subsequent presentation. Upon storing the commercial content for subsequent presentation, the record engine 165 of FIG. 1 in some implementations can mark the data to be saved until deletion is requested by a user. In further implementations, the record engine 165 can perform confirmation or authentication of a user before allowing the user to delete the data. The method 600 then ends at block 655.

Returning to step 640, if the content is not commercial content, the method 600 proceeds to step 660. At step 660 the method 600 determines whether the content is future content. As an example, step 660 can be performed by the presentation engine 160 of FIG. 1. If the content is future content, the method 600 proceeds to step 665, where the method 600 determines how to present the content (e.g., whether to set a reminder to notify the user when the content is being presented, to automatically change the channel to present the content when the content is scheduled to be presented, or to automatically record the content at the scheduled presentation time). As an example, step 665 can be performed by the presentation engine 160 of FIG. 1. The determination can be made based on predefined user preferences. Alternatively, the determination can be made based upon a user selection from among a number of options, including the options outlined above. The method 600 then ends at step 655.

Returning to step 660, if the content is not future content, the method 600 determines whether to record the content or present the content to the user (e.g., based upon user preferences). As an example, step 670 can be performed by the presentation engine 160 of FIG. 1. User preferences can be set in advance. Alternatively, the user preference can be determined by prompting the user and the receiving the user'selection using the user interface. The method 600 then ends at step 655.

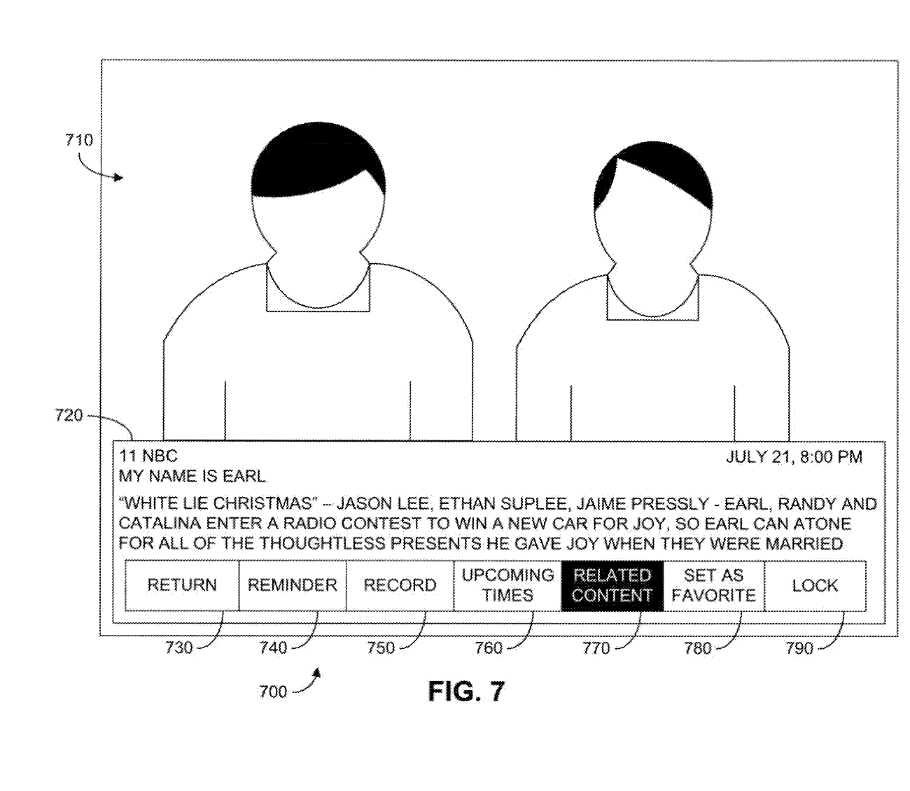

FIG. 7 depicts an example user interface 700 displaying a content presentation 710 and an information interface 720. In this example implementation, the information interface 720 includes a number of button representations 730-790. In various implementations of the media system 100, a browsing engine 155 in conjunction with a user interface engine 145 can generate the information interface 720 and the button representation 730-790.

The button representations, in some implementations, can include a return button representation 730, a reminder button representation 740, a record button representation 750, an upcoming times button representation 760, a related content button representation 770, a favorite button representation 780, and a lock button representation 790. The return button representation 730, upon selection, can cause the user interface to display the previous screen (e.g., the content presentation, an interactive program guide, etc.). The reminder button representation 740, upon selection, can cause the user interface, for example, to display a list of reminders set by the user and recorded by the media system. The record button representation 750, upon selection can cause the user interface to record the currently selected content (e.g., the currently displayed program) to a data store 110. The upcoming times button representation 760, upon selection, can cause the user interface to display a list of upcoming times for the currently selected content (e.g., the currently displayed program) based upon a search of metadata stored in the data store 110. The related content button representation 770, upon selection, can cause the media system to perform a search for related content (e.g., related commercial content) from a network (e.g., the internet), and to display a list of related content responsive to the search results received. The favorite button representation 780, upon selection, allows a user to set a currently selected channel as a favorite. The lock button representation 790, upon selection, allows a user to set a currently selected channel to be locked, so as to inhibit a user from accessing the channel without providing credentials (e.g., a password).

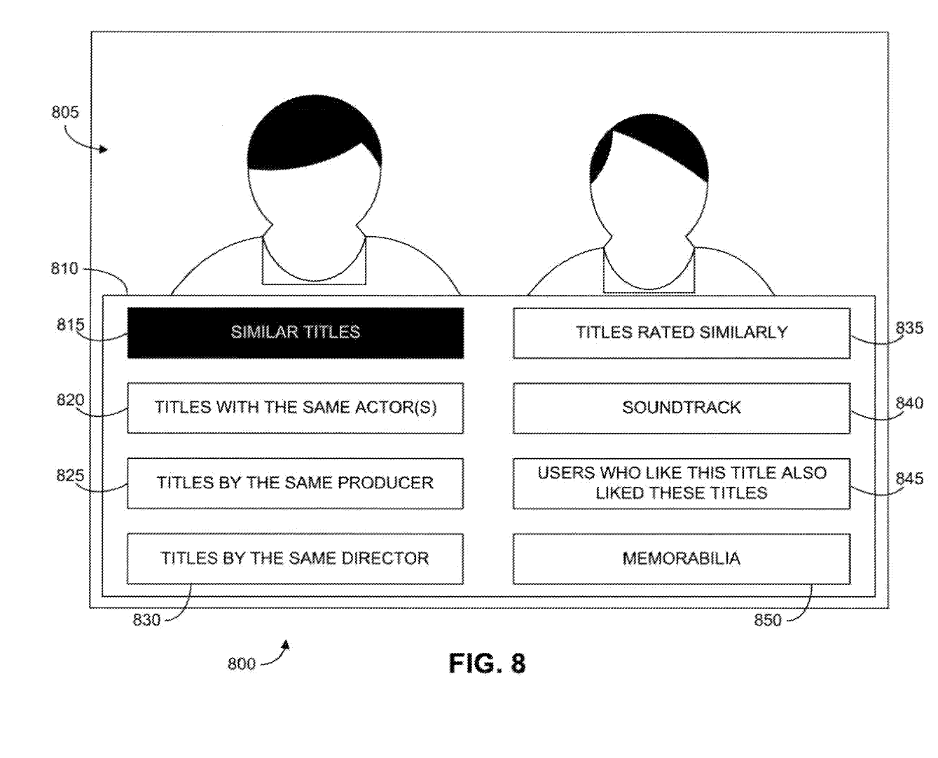

FIG. 8 depicts an example user interface 800 displaying a content presentation 805 and an menu interface 810. The menu interface 810 includes a number of button representations 815-850, which can be selectable to the user. In various implementations of the media system 100, a browsing engine 155 in conjunction with a user interface engine 145 can generate the menu interface 810 and the button representations 815-850.

The button representations 815-850 can include a number of search templates, which can be used by the correlation engine 175 to extract search criteria from the metadata and to search for related content. In various example implementations, the search templates can include a “similar titles” button representation 815, which upon selection can cause the correction engine 175 to extract the title from the metadata associated with the currently selected content (e.g., the content currently being presented to the user). The correlation engine 175 can then execute a search template to search a network for related content.

Another example of a button representation that can be included in some implementations is a “titles with the same actor(s)” button representation 820. Upon selection, the “titles with the same actor(s)” button representation can cause the correlation engine 175 to extract actor(s) or actress(es) from the metadata associated with the currently selected content (e.g., the content currently being presented to the user). The search template can further allow a user to select from among the actor(s) or actress(es) extracted from the metadata in order to find content that includes a subset of the actor(s) or actress(es) extracted from the metadata. Further, in some implementations, the search template may instruct the correlation engine 175 to extract the title of the currently selected content, and to perform a network search for all actor(s) or actress(es) associated with the title. The search template can then allow the user to select from the actor(s) or actress(es) associated with the title in order to perform the search for content including the selected actor(s) or actress(es). Moreover, in some implementations, the search template can allow the user to select to search for content including all of the selected actor(s) or actress(es), or to select to search for content including any of the selected actor(s) or actress(es). Similarly, some implementations can allow the user to search based upon the presence of one or more actors and the absence of other actor(s).

The search templates can also include a “titles by the same producer” button representation 825, which upon selection can cause the correlation engine 175 to extract producer(s) from the metadata associated with the currently selected content (e.g., the content currently being presented to the user). The correlation engine 175 can then execute a search template to search a network for related content using the extracted producer information as a search criteria. The search template can further allow a user to select from among multiple producers extracted from the metadata, if there are multiple producers, in order to find content that includes a subset of the producers extracted from the metadata. Further, in some implementations, the search template can instruct the correlation engine 175 to extract the title of the currently selected content, and to perform a network search for producers associated with the title. The search template can then allow the user to select a producer associated with the title in order to perform the search for content including the producer. Moreover, in some implementations, the search template can allow the user customize a search. Customized searches can allow the user to locate content, for example, that includes specific producers and actors, or to find content where a specific producer worked alone (e.g., without a co-producers(s)), etc. The correlation engine 175 can then execute a search template to search a network for content with the same producer(s), or any subset thereof.

The search templates can also include a “titles by the same director” button representation 830, which upon selection can cause the correlation engine 175 to extract director(s) from the metadata associated with the currently selected content (e.g., the content currently being presented to the user). The correlation engine 175 can then execute a search template to search a network for related content using the extracted director information as a search criteria. The search template can further allow a user to select from among multiple directors extracted from the metadata, if there are multiple directors, in order to find content that includes a subset of the directors extracted from the metadata. Further, in some implementations, the search template can instruct the correlation engine 175 to extract the title of the currently selected content, and to perform a network search for directors associated with the title. The search template can then allow the user to select a director associated with the title in order to perform the search for content including the director. Moreover, in some implementations, the search template can allow the user customize a search. Customized searches can allow the user to locate content, for example, that includes specific directors and actors, or to find content where a specific director worked along (e.g., without co-director(s)), or any other customized search. The correlation engine 175 can then execute a search template to search a network for content with the same director(s), or any subset thereof.

The search templates can also include a “titles rated similarly” button representation 835, which upon selection can cause the correlation engine 175 to extract, for example, critic's rating information from the metadata associated with the currently selected content (e.g., the content currently being presented to the user). The correlation engine 175 can then execute a search template to search a network for related content using the extracted rating information as a search criteria. In some implementations, the search template can instruct the correlation engine 175 to extract the title of the currently selected content, and to perform a network search for critics or ratings associated with the title. In some implementations, the search template can then allow the user to select a from among several ratings and/or critics associated with title in order to perform the search for content. The correction engine 175 can execute a search template to search a network for content with a similar rating.

The search templates can also include a “soundtrack” button representation 840, which upon selection can cause the correlation engine 175 to extract soundtrack information from the metadata associated with the currently selected content (e.g., the content currently being presented to the user). The correlation engine 175 can then execute a search template to search a network for related content using the extracted soundtrack information as a search criteria. Further, in some implementations, there is no soundtrack information included in the metadata, so the search template can instruct the correlation engine to extract the title of the currently selected content, and to perform a network search for soundtracks associated with the title. The search template can then allow the user to select a soundtrack associated with the title in order to perform the search for content including the soundtrack. The correlation engine 175 can then execute a search template to search a network for content including the soundtrack.

The search templates can also include a “users who liked this title also liked these titles” button representation 845, which upon selection can cause the correlation engine 175 to extract a title from the metadata associated with the currently selected content (e.g., the content currently being presented to the user). The correlation engine 175 can then execute a search template to search a network for related content using the extracted title information as a search criteria. In some implementations, the correlation engine 175 can allow the user to associate scoring information with a number of titles and store the scoring information in the data store. This scoring information can then be used to identify user preferences. For example, over a large number of users, it can be considered likely that some users have similar tastes. Thus, when a user'scores correlate with another user's scores, it may be possible that is one of the users has seen additional titles and scored those titles highly, that the other user would score these titles highly as well, and vice-versa. The correlation engine 175 can then execute a search template to search a network for content that has been identified as being liked by people who liked the extracted title (e.g., people who scored the extracted title well also score these other titles well).

The search templates can also include a “memorabilia” button representation 850, which upon selection can cause the correlation engine 175 to extract a title from the metadata associated with the currently selected content (e.g., the content currently being presented to the user). The correlation engine 175 can then execute a search template to search a network for related memorabilia content using the extracted title information as a search criteria. In some implementations, the correlation engine 175 can extract any other information from the metadata and use such information to locate memorabilia content.

In some implementations, the search template can have predetermined knowledge regarding a number of websites which compile and make available information on similar titles (e.g., titles that are classified in similar genres). These websites can be searched using any of a number of different searching mechanisms, including, for example, a web crawler or a web scraper to automatically browse the predetermined websites for similar titles, titles with the same actor(s) or actress(es), titles by the same producer, titles by the same director, titles rated similarly, soundtracks associated with the title, titles rated highly by users who liked this title, memorabilia associated with the title, etc. Alternatively, the correlation engine 175 can use a search engine on the site to perform a search for commercial content related to the title.

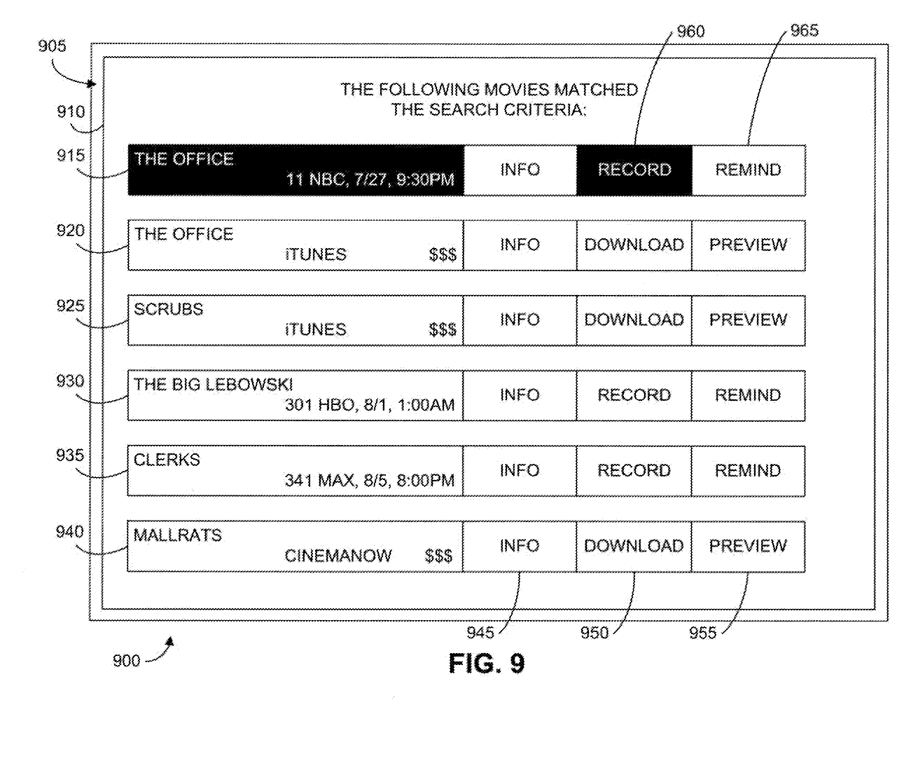

FIG. 9 depicts an example user interface 900 displaying a content presentation 905 and an menu interface 810 displaying related content displayed in FIGS. 7 and 8, and based upon the selection of similar titles from the menu interface of FIG. 8. While the presentation 905 in this example is hidden behind the menu interface 910, however in other examples, the menu interface 910 may be collapsed or otherwise enable viewing of part or all of the presentation 905. The menu interface 910 can include a number of show representations 915-940, which can be selectable by the user. In various implementations of the media system 100, a browsing engine 155 in conjunction with a user interface engine 145 can generate the menu interface 910 and the show representations 915-940. User interface 900 can display a list of related content matching the search criteria received from the user through the user interface.

In this example implementation, each of the button representations 915-940 include a number of presentation preference selections 945-965. In one implementation, the user can highlight a show (as is shown by show representation 915) using, for example, a traditional up or down arrow button on the remote control or another media system interface. Alternatively, a touch actuated rotational input device can be used, such that the user interfaces with the remote control by moving a finger around the rotational input device. Upon highlighting the desired show representation 915-940, the user can press a select button (e.g., enter button), thereby activating the ability to scroll through the preference selections 945-965, while deactivating the ability to scroll through the show representations 915-940.

In various examples, the preference selections 945-965 can include an “Info” preference selection 945, a “Download” preference selection 950, a “Preview” preference selection 955, a “Record” preference selection 960, or a “Remind” preference selection 965. In this example, the “Info,” “Download” and “Preview” preference selections 945-955 can be associated with downloadable media content, while the “Info,” “Record” and “Remind” preference selections 945, 960, 965 can be associated with upcoming broadcast content.

The “Info” preference selection 945 can cause the media system 100 to display metadata associated with the currently selected content. The metadata can be previously downloaded and retrieved from a metadata data store. Alternatively, the media system 100 can use a search engine 170 to retrieve information associated with the currently selected content.

The “Download” preference selection 950 can cause the media system 100 to a download content associated with the currently selected content. In various implementations, the media system 100 can confirm downloading of commercial content, in order to ensure an enforceable agreement to pay a cost associated with the downloaded content. In such instances, the media system can also be configured to display a price associated with the commercial content. In further implementations, the menu interface can be further configured to request a preference from the user whether to present the content using the presentation engine and/or to record the commercial content to a data store.

The “Preview” preferences selection 955 can cause the media system 100 to retrieve a short preview clip from, from example, the commercial content provider (if a preview is available). Upon retrieval of a preview clip, the media system 100 can display a preview clip associated with the currently selected content to the user using an external or internal display. The end of a preview clip may prompt the media system 100 to request input from the user to select whether to download the rest of the related commercial content for a fee, or to return to a previous menu or presentation.

The “Record” preference selection 960 can cause the media system 100 to schedule a future recording at the schedule time the broadcast content will aired. Alternatively, when the content is being broadcast currently, the “Record” preference selection 960 can cause the media system 100 to tune the currently selected content and record the currently selected content to a data store.

The “Remind” preference selection 965 can cause the media system 100 to schedule a reminder for the user. Upon ripening of the reminder, the media system 100 can notify a user that content may be broadcast on a channel for which the user previously set a reminder. Reminders can be used to remind users of content, where the user may not want to record the content, but rather to watch the content as it is being broadcast.

The systems and methods disclosed herein may use data signals conveyed using networks (e.g., local area network, wide area network, internet, etc.), fibre optic medium, carrier waves, wireless networks, etc. for communication with one or more data processing devices (e.g., media systems). The data signals can carry any or all of the data disclosed herein that is provided to or from a device.

The methods and systems described herein may be implemented on many different types of processing devices by program code comprising program instructions that are executable by one or more processors. The software program instructions may include source code, object code, machine code, or any other stored data that is operable to cause a processing system to perform methods described herein.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and data structures described herein may be connected directly or indirectly to each other in order to allow the flow of data needed for their operations. It is also noted that software instructions or a module can be implemented for example as a subroutine unit of code, or as a software function unit of code, or as an object (as in an object-oriented paradigm), or as an applet, or in a computer script language, or as another type of computer code or firmware. The software components and/or functionality may be located on a single device or distributed across multiple devices depending upon the situation at hand.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

These and other implementations are within the scope of the following claims.

What is claimed is:

1. A media system, comprising:
a video input operable to receive video content from a content provider;
a network interface operable to send content requests and to receive commercial content from a commercial content provider;
a metadata input operable to receive metadata from a metadata provider, the metadata being associated with video content or the commercial content;
a correlation engine operable to extract at least a portion of the metadata associated with the video content or the commercial content and to request related commercial content using the network interface, the related commercial content being based upon the extracted portion of metadata and input received from a user.

2. The system of claim 1, wherein the correlation engine is further operable to extract at least a portion of the metadata associated with the video content or the commercial content, and to request related video content from the content provider.

3. The system of claim 2, further comprising a menu interface operable to receive metadata associated with the related video content and the related commercial content, and to prompt the user to select from among at least the related commercial content and the related video content based upon the metadata.

4. The system of claim 3, wherein selection of related commercial content includes receipt of acceptance from the user to purchase the related commercial content, the system being operable to download the related commercial content from a third party responsive to receipt of the acceptance.

5. The system of claim 1, further comprising one or more network search templates, a network search template defining the at least one portion of metadata to be extracted.

6. The system of claim 5, further comprising a menu interface, the menu interface being operable to prompt the user to select from one or more menu options, one or more of the one or more menu options being associated with one of the one or more network search templates.

7. The system of claim 1, wherein the metadata provider is the content provider.

8. The system of claim 1, wherein the related commercial content is video or music content that can be downloaded for an additional charge.

9. The system of claim 1, wherein the related commercial content are offers for products that can be ordered for an additional charge.

10. The system of claim 1, wherein the commercial content provider is the content provider.

11. The system of claim 1, wherein the commercial content provider is a third party content provider.

12. The system of claim 1, wherein the video content is broadcast content pushed to the media system by the content provider, and the commercial content is pulled from the commercial content provider.

13. The system of claim 1, further comprising a data store operable to store video and commercial content along with associated metadata for subsequent playback using a display, wherein the correlation engine is operable to extract metadata from stored video or commercial content and to request related commercial content using at least the network interface.

14. The system of claim 1, further comprising:
wherein the correlation engine is operable to receive the at least one portion of the metadata, and to cause a search engine to search the network for related items;
a metadata search engine operable to search among metadata received from the metadata provider for upcoming video content matching the related items; and
wherein the network search interface module is further operable to cause a search engine to search for related items comprising commercial content for download from the commercial content provider.

15. The system of claim 1, further comprising a menu interface engine operable to cause a display to display a menu interface to a user, the menu interface comprising a plurality of searching options which, upon selection by a user, cause the network search interface to perform a search for related items based upon currently displayed video content.

16. A method of providing commercial content, comprising:
a receiving one or more of broadcast content or commercial content from a content provider;
receiving metadata from a metadata provider, the metadata being associated with the received content;
extracting metadata associated with the received content;
searching a network for commercial content related to the extracted metadata; and
receiving related commercial content from the content provider based on the extracted metadata.

17. The method of claim 16, further comprising:
searching for related broadcast content from the content provider, and
receiving related broadcast content from the content provider.

18. The method of claim 17, further comprising:
receiving metadata associated with the related broadcast content and the related commercial content; and
prompting the user to select from among at least the related commercial content and the related broadcast content based upon the metadata.

19. The method of claim 18, further comprising:
receiving an acceptance from the user to purchase the related commercial content; and
downloading the related commercial content from the third party responsive to receipt of the acceptance.

20. The method of claim 16, further comprising using one or more network search templates to search the network, network search templates defining said at least one portion of metadata to be extracted.

21. The method of claim 20, further comprising prompting the user to select from one or more menu options, one or more of the one or more menu options being associated with one of the one or more network search templates.

22. The method of claim 16, wherein the metadata provider is the content provider.

23. The method of claim 16, wherein the related commercial content is video or music content that can be downloaded for an additional charge paid to at least a third party.

24. The method of claim 16, wherein the related commercial content are offers for products that can be ordered for an additional charge paid to at least a third party.

25. The method of claim 16, wherein the content provider comprises a broadcast content provider and a commercial content provider.

26. The method of claim 25, wherein the commercial content provider is a third party content provider.

27. The method of claim 25, wherein the broadcast content is pushed to the media system by the broadcast content provider, and the commercial content is pulled to the media system from the commercial content provider.

28. The method of claim 16, further comprising:
storing broadcast content and commercial content along with associated metadata for subsequent playback using a display; and
extracting metadata from stored broadcast or commercial content.

29. A media system, comprising:
a video input operable to receive video content from a content provider;
a network interface operable to send content requests and to receive commercial content from a commercial content provider;
a metadata input operable to receive metadata from a metadata provider, the metadata being associated with video content or the commercial content;
a correlation engine operable to develop search criteria based upon at least a portion of the metadata associated with the video content or the commercial content, and to request related commercial content using the network interface, the related commercial content being based upon the developed search criteria.
